(19) United States
(12) Patent Application Publication
(10) Pub. No.: US 2006/0280270 A1
(43) Pub. Date: Dec. 14, 2006

(54) Method and system for FM communication

(76) Inventors: Brima Ibrahim, Aliso Viejo, CA (US); Bojko Marholev, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/434,408

(22) Filed: May 15, 2006

Related U.S. Application Data
(60) Provisional application No. 60/685,239, filed on May 26, 2005.

(51) Int. Cl. H04L 7/00

(52) U.S. Cl. 375/354

(57) ABSTRACT

Aspects of a method and system for FM communication are provided. An FM transceiver may generate FM radio frequency signals for transmission by modulating a single PLL within the FM transceiver via at least one modulation point with a frequency modulated multiplexed audio signal. The single PLL may also generate signals for downconversion of FM radio signals received by the transceiver. The single PLL may be modulated via a first modulation point in a feedback loop in the single PLL. In some instances, a reference frequency path within the single PLL may be selected to achieve the appropriate loop bandwidth for generating the FM radio signal for transmission. A second modulation point may be achieved by adding the modulated multiplexed audio signal to an input of a VCO within the single PLL. Moreover, the single PLL may be modulated via the first and second modulation points concurrently.

### CROSS-REFERENCE TO RELATED APPLICATIONS/INCORPORATION BY REFERENCE

The application makes reference to, claims priority to, and claims the benefit of U.S. Provisional Application Ser. No. 60/685,239 filed on May 26, 2005.

This application also makes reference to U.S. application Ser. No. 11/286,555 filed on Nov. 22, 2005.

The above stated applications are hereby incorporated by reference in their entirety.

### FIELD OF THE INVENTION

Certain embodiments of the invention relate to radio communication technologies. More specifically, certain embodiments of the invention relate to a method and system for FM communication.

### BACKGROUND OF THE INVENTION

With the popularity of portable electronic devices and wireless devices that support audio applications, there is a growing need to provide a simple and complete solution for audio communications applications. For example, some users may utilize Bluetooth-enabled devices, such as headphones and/or speakers, to allow them to communicate audio data with their wireless handset while freeing to perform other activities. Other users may have portable electronic devices that may enable them to play stored audio content and/or receive audio content via broadcast communication, for example.

However, integrating multiple audio communication technologies into a single device may be costly. Combining a plurality of different communication services into a portable electronic device or a wireless device may require separate processing hardware and/or separate processing software. Moreover, coordinating the reception and/or transmission of data to and/or from the portable electronic device or a wireless device may require significant processing overhead that may impose certain operation restrictions and/or design challenges. For example, a handheld device such as a cell phone that incorporates Bluetooth and Wireless LAN may pose certain coexistence problems caused by the close proximity of the Bluetooth and WLAN transceivers.

Furthermore, simultaneous use of a plurality of radios in a handheld may result in significant increases in power consumption. Power being a precious commodity in most wireless mobile devices, combining devices such as a cellular radio, a Bluetooth radio and a WLAN radio requires careful design and implementation in order to minimize battery usage. Additional overhead such as sophisticated power monitoring and power management techniques are required in order to maximize battery life.

For example, a first type of radio and second type of radio may be combined into a portable electronic or wireless device. In this regard, data processing operations may be performed in separate processors for data for the first type of radio and data for the second type of radio. Processing of algorithms that handle data processing for the first type of radio may be performed with the aid of co-processors, for example. However, separate processing resources for each radio operation may result in increased hardware complexity and cost. This is turn may result in added power consumption that may reduce the time that the device may be in use between recharges. Moreover, separate processing may make more difficult the coordination and/or cooperation between communication protocols.

Moreover, reducing power and/or area requirements within each radio type may also be necessary in order to meet requirements such as footprint, battery consumption and cost. In this regard, careful design may require efficient use of circuitry and/or system components within each radio type to further enable simultaneous use of a plurality of radios in a single handheld device.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for FM communication, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary FM transmitter that communicates with handlheld devices that utilize a single chip with integrated Bluetooth and FM radios, in accordance with an embodiment of the invention.

FIG. 1B is a block diagram of an exemplary FM receiver that communicates with handlheld devices that utilize a single chip with integrated Bluetooth and FM radios, in accordance with an embodiment of the invention.

FIG. 1C is a block diagram of an exemplary single chip with integrated Bluetooth and FM radios that supports multiple interfaces, in accordance with an embodiment of the invention.

FIG. 2 is a block diagram of an exemplary single chip that supports Bluetooth and FM operations with an integrated FM transmitter, in accordance with an embodiment of the invention.

FIG. 3A is a diagram illustrating an exemplary multiplexed audio signal, in accordance with an embodiment of the invention.

FIG. 3B is a block diagram illustrating an exemplary integrated Bluetooth and FM transceiver and an MPX CODEC, in accordance with an embodiment of the invention.

FIG. 4A is a block diagram of an exemplary single modulation point FM transceiver with modulated PLL feedback divider, in accordance with an embodiment of the invention. Referring to FIG. 4, there is shown an FM transceiver 400

FIG. 4B is a block diagram of an exemplary single modulation point FM transceiver with additional reference frequency path in PLL for transmission operations, in accordance with an embodiment of the invention.

FIG. 4C is a block diagram of an exemplary single modulation point FM transceiver with added modulated transmit signal to VCO, in accordance with an embodiment of the invention.

FIG. 4D is a block diagram of an exemplary double modulation point FM transceiver, in accordance with an embodiment of the invention.

FIG. 5 is a flow diagram of the operation of an FM transceiver with at least one modulation point, in accordance with an embodiment of the invention.

### DETAILED DESCRIPTION OF THE INVENTION

Certain embodiments of the invention may be found in a method and system for FM communication. In various aspects of the invention, an FM transceiver may generate FM radio frequency signals for transmission by modulating a single PLL within the FM transceiver via at least one modulation point with a frequency modulated multiplexed audio signal. The single PLL may also generate signals for downconversion of FM radio signals received by the transceiver. The single PLL may be modulated via a first modulation point in a feedback loop in the single PLL. In some instances, a reference frequency path within the single PLL may be selected to achieve the appropriate loop bandwidth for generating the FM radio signal for transmission. A second modulation point may be achieved by adding the modulated multiplexed audio signal to an input of a VCO within the single PLL. Moreover, the single PLL may be modulated via the first and second modulation points concurrently.

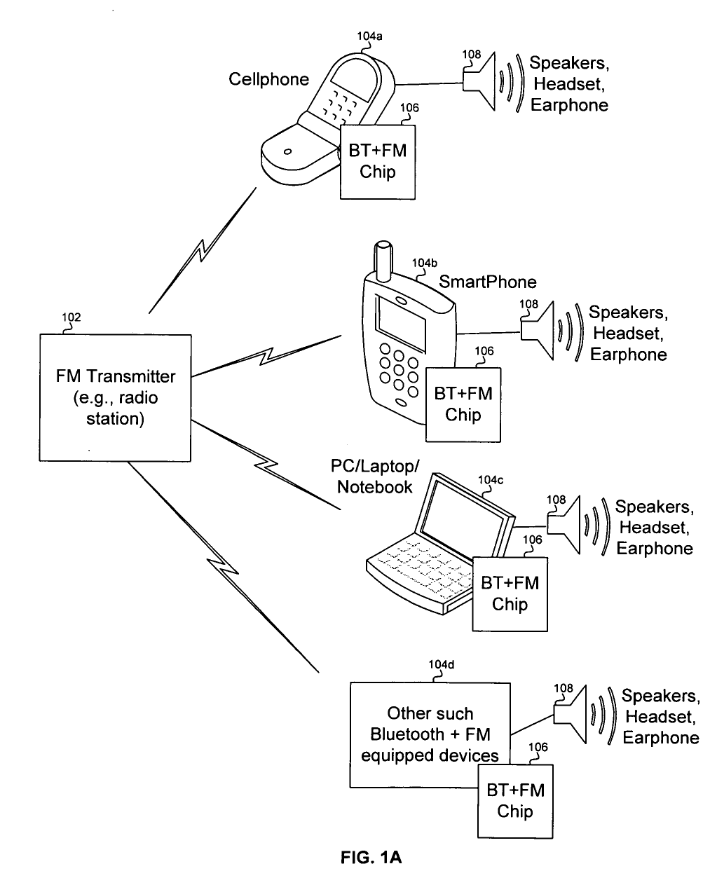

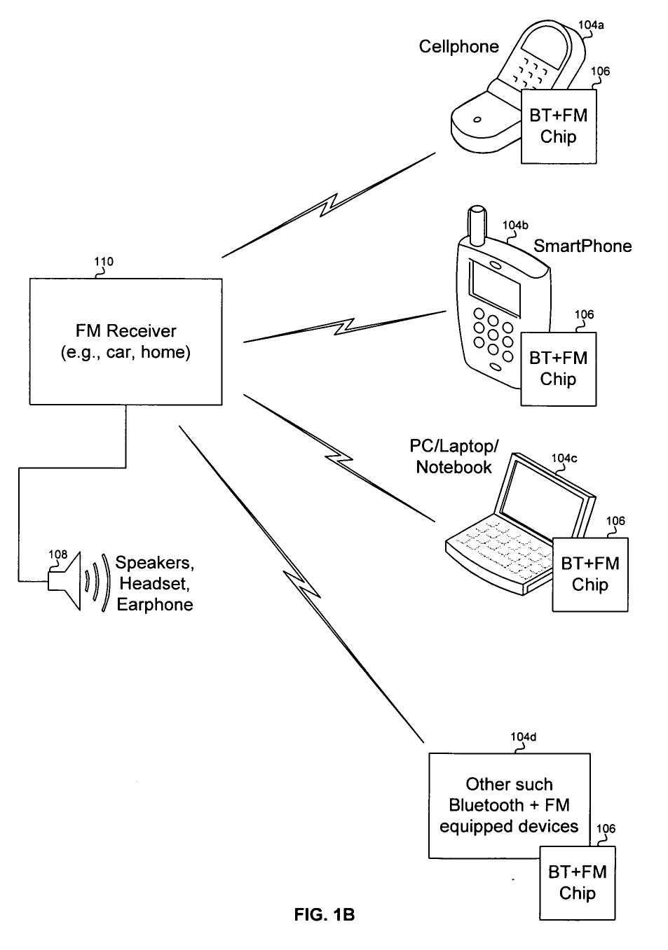

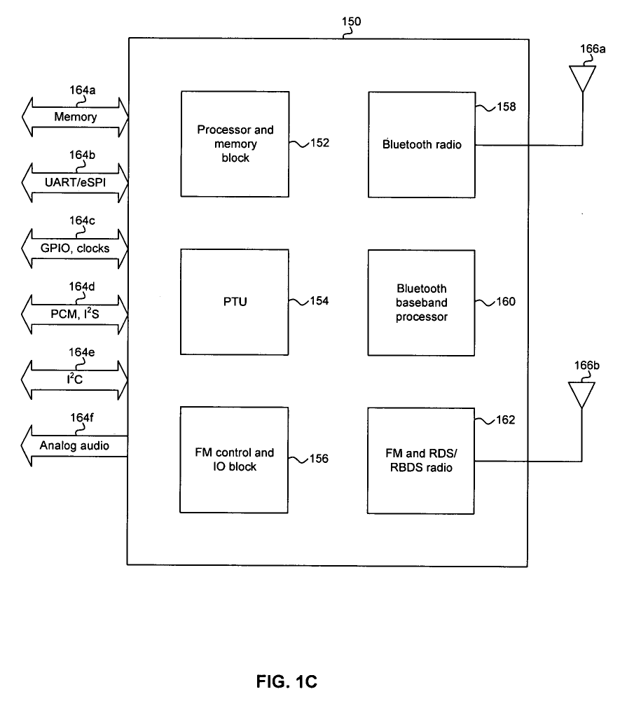

FIG. 1A is a block diagram of an exemplary FM transmitter that communicates with handlheld devices that utilize a single chip with integrated Bluetooth and FM radios, in accordance with an embodiment of the invention. Referring to FIG. 1A, there is shown an FM transmitter 102, a cellular phone 104a, a smart phone 104b, a computer 104c, and an exemplary FM and Bluetooth-equipped device 104d. The FM transmitter 102 may be implemented as part of a radio station or other broadcasting device, for example. Each of the cellular phone 104a, the smart phone 104b, the computer 104c, and the exemplary FM and Bluetooth-equipped device 104d may comprise a single chip 106 with integrated Bluetooth and FM radios for supporting FM and Bluetooth data communications. The FM transmitter 102 may enable communication of FM audio data to the devices shown in FIG. 1A by utilizing the single chip 106. Each of the devices in FIG. 1A may comprise and/or may be communicatively coupled to a listening device 108 such as a speaker, a headset, or an earphone, for example.

The cellular phone 104a may be enabled to receive an FM transmission signal from the FM transmitter 102. The user of the cellular phone 104a may then listen to the transmission via the listening device 108. The cellular phone 104a may comprise a “one-touch” programming feature that enables pulling up specifically desired broadcasts, like weather, sports, stock quotes, or news, for example. The smart phone 104b may be enabled to receive an FM transmission signal from the FM transmitter 102. The user of the smart phone 104b may then listen to the transmission via the listening device 108.

The computer 104c may be a desktop, laptop, notebook, tablet, and a PDA, for example. The computer 104c may be enabled to receive an FM transmission signal from the FM transmitter 102. The user of the computer 104c may then listen to the transmission via the listening device 108. The computer 104c may comprise software menus that configure listening options and enable quick access to favorite options, for example. In one embodiment of the invention, the computer 104c may utilize an atomic clock FM signal for precise timing applications, such as scientific applications, for example. While a cellular phone, a smart phone, computing devices, and other devices have been shown in FIG. 1A, the single chip 106 may be utilized in a plurality of other devices and/or systems that receive and use Bluetooth and/or FM signals. In one embodiment of the invention, the single chip Bluetooth and FM radio may be utilized in a system comprising a WLAN radio. The U.S. application Ser. No. 11/286,844, filed on Nov. 22, 2005, discloses a method and system comprising a single chip Bluetooth and FM radio integrated with a wireless LAN radio, and is hereby incorporated herein by reference in its entirety.

FIG. 1B is a block diagram of an exemplary FM receiver that communicates with handlheld devices that utilize a single chip with integrated Bluetooth and FM radios, in accordance with an embodiment of the invention. Referring to FIG. 1B, there is shown an FM receiver 110, the cellular phone 104a, the smart phone 104b, the computer 104c, and the exemplary FM and Bluetooth-equipped device 104d. In this regard, the FM receiver 110 may comprise and/or may be communicatively coupled to a listening device 108. A device equipped with the Bluetooth and FM transceivers, such as the single chip 106, may be able to broadcast its respective signal to a “deadband” of an FM receiver for use by the associated audio system. For example, a cell phone or a smart phone, such as the cellular phone 104a and the smart phone 104b, may transmit a telephone call to an automobile FM receiver for listening over the audio system of the automobile, via usage of a deadband area of the car's FM stereo system. One advantage may be the universal ability to use this feature with all automobiles equipped simply with an FM radio with few, if any, other external FM transmission devices or connections being required.

In another example, a computer, such as the computer 104c, may comprise an MP3 player or another digital music format player and may broadcast a signal to the deadband of an FM receiver in a home stereo system. The music on the computer may then be listened to on a standard FM receiver with few, if any, other external FM transmission devices or connections. While a cellular phone, a smart phone, and computing devices have been shown, a single chip that combines a Bluetooth and FM transceiver and/or receiver may be utilized in a plurality of other devices and/or systems that receive and use an FM signal.

FIG. 1C is a block diagram of an exemplary single chip with integrated Bluetooth and FM radios that supports multiple interfaces, in accordance with an embodiment of the invention. Referring to FIG. 1F, there is shown a single chip 150 that supports Bluetooth and FM radio communications. The single chip 150 may comprise a processor and memory block 152, a PTU 154, an FM control and input-output (IO) block 156, a Bluetooth radio 158, a Bluetooth baseband processor 160, and an FM and radio data system (RDS) and radio broadcast data system (RDBS) radio 162. A first antenna or antenna system 166a may be communicatively coupled to the Bluetooth radio 158. A second antenna or antenna system 166b may be communicatively coupled to the FM and RDS/RBDS radio 162.

The processor and memory block 152 may comprise suitable logic, circuitry, and/or code that may enable control, management, data processing operations, and/or data storage operations, for example. The PTU 154 may comprise suitable logic, circuitry, and/or code that may enable interfacing the single chip 150 with external devices. The FM control and IO block 156 may comprise suitable logic, circuitry, and/or code that may enable control of at least a portion of the FM and RDS/RBDS radio 162. The Bluetooth radio 158 may comprise suitable logic, circuitry, and/or code that may enable Bluetooth communications via the first antenna 166a. The FM and RDS/RBDS radio 162 may comprise suitable logic, circuitry, and/or code that may enable FM, RDS, and/or RBDS data communication via the second antenna 166b. The Bluetooth baseband processor 160 may comprise suitable logic, circuitry, and/or code that may enable processing of baseband data received from the Bluetooth radio 158 or baseband data to be transmitted by the Bluetooth radio 158.

The PTU 154 may support a plurality of interfaces. For example, the PTU 154 may support an external memory interface 164a, a universal asynchronous receiver transmitter (UART) and/or enhanced serial peripheral interface (eSPI) interface 164b, a general purpose input/output (GPIO) and/or clocks interface 164c, a pulse-code modulation (PCM) and/or an inter-IC sound (I²S) interface 164d, an inter-integrated circuit (I²C) bus interface 164e, and/or an analog audio interface 164f.

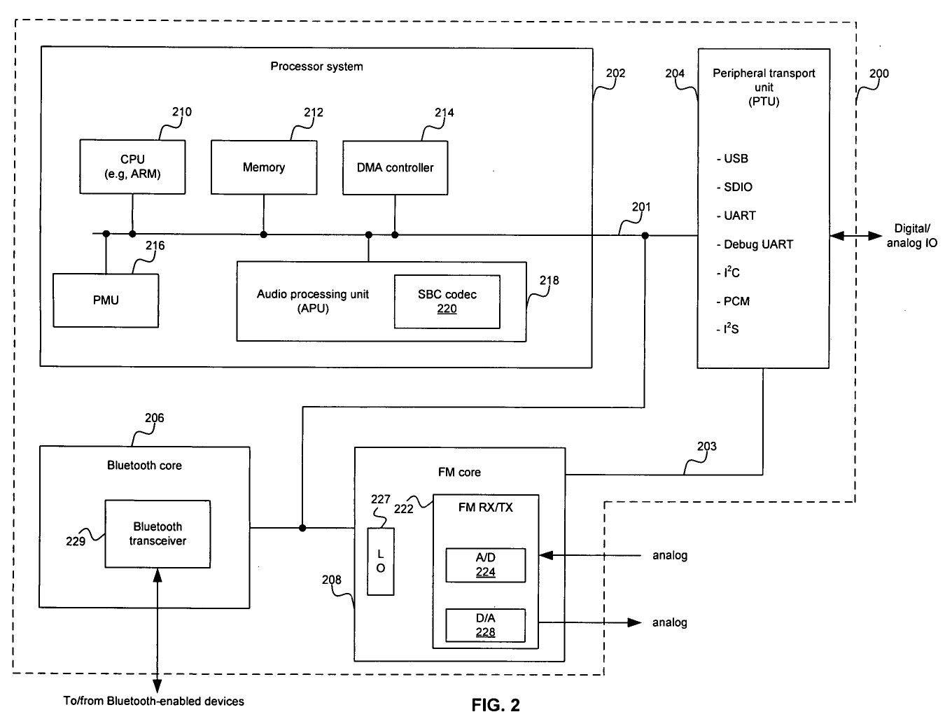

FIG. 2 is a block diagram of an exemplary single chip that supports Bluetooth and FM operations with an integrated FM transmitter, in accordance with an embodiment of the invention. Referring to FIG. 2, there is shown a single chip 200 that may comprise a processor system 202, a peripheral transport unit (PTU) 204, a Bluetooth core 206, a frequency modulation (FM) core 208, and a common bus 201.

The processor system 202 may comprise a central processing unit (CPU) 210, a memory 212, a direct memory access (DMA) controller 214, a power management unit (PMU) 216, and an audio processing unit (APU) 218. The APU 218 may comprise a subband coding (SBC) CODEC 220. At least a portion of the components of the processor system 202 may be communicatively coupled via the common bus 201.

The CPU 210 may comprise suitable logic, circuitry, and/or code that may enable control and/or management operations in the single chip 200. In this regard, the CPU 210 may communicate control and/or management operations to the Bluetooth core 206, the FM core 208, and/or the PTU 204 via a set of register locations specified in a memory map. Moreover, the CPU 210 may be utilized to process data received by the single chip 200 and/or to process data to be transmitted by the single chip 200. The CPU 210 may enable processing of data received via the Bluetooth core 206, via the FM core 208, and/or via the PTU 204. For example, the CPU 210 may enable processing of A2DP data and may then transfer the processed A2DP data to other components of the single chip 200 via the common bus 201. In this regard, the CPU may utilize the SBC CODEC 220 in the APU 218 to encode and/or decode A2DP data, for example. The CPU 210 may enable processing of data to be transmitted via Bluetooth core 206, via the FM core 208, and/or via the PTU 204. The CPU 210 may be, for example, an ARM processor or another embedded processor core that may be utilized in the implementation of system-on-chip (SOC) architectures.

The CPU 210 may time multiplex Bluetooth data processing operations and FM data processing operations. In this regard, the CPU 210 may perform each operation by utilizing a native clock, that is, Bluetooth data processing based on a Bluetooth clock and FM data processing based on an FM clock. The Bluetooth clock and the FM clock may be distinct and may not interact. The CPU 210 may gate the FM clock and the Bluetooth clock and may select the appropriate clock in accordance with the time multiplexing scheduling or arrangement. When he CPU 210 switches between Bluetooth operations and FM operations, at least certain states associated with the Bluetooth operations or with the FM operations may be retained until the CPU 210 switches back.

For example, in the case where the Bluetooth function is not active and is not expected to be active for some time, the CPU 210 may run on a clock derived from the FM core 208. This may eliminate the need to bring in a separate high-speed clock when one is already available in the FM core 208. In the case where the Bluetooth core 206 may be active, for example when the Bluetooth is in a power-saving mode that requires it to be active periodically, the processor may chose to use a clock derived separately from the FM core 208. The clock may be derived directly from a crystal or oscillator input to the Bluetooth core 206, or from a phase locked loop (PLL) in the Bluetooth core 206. While this clocking scheme may provide certain flexibility in the processing operations performed by the CPU 210 in the single chip 200, other clocking schemes may also be implemented.

The CPU 210 may also enable configuration of data routes to and/or from the FM core 208. For example, the CPU 210 may configure the FM core 208 so that data may be routed via an I²S interface or a PCM interface in the PTU 204 to the analog ports communicatively coupled to the PTU 204.

The CPU 210 may enable tuning, such as flexible tuning, and/or searching operations in Bluetooth and/or FM communication by controlling at least a portion of the Bluetooth core 206 and/or the FM core 208. For example, the CPU 210 may generate at least one signal that tunes the FM core 208 to a certain frequency to determine whether there is a station at that frequency. When a station is found, the CPU 210 may configure a path for the audio signal to be processed in the single chip 200. When a station is not found, the CPU 210 may generate at least one additional signal that tunes the FM core 208 to a different frequency to determine whether a station may be found at the new frequency.

Searching algorithms may enable the FM core 208 to scan up or down in frequency from a presently tuned channel and stop on the next channel with received signal strength indicator (RSSI) above a threshold. The search algorithm may be able to distinguish image channels. The choice of the IF frequency during search is such that an image channel may have a nominal frequency error of 50 kHz, which may be used to distinguish the image channel from the “on” channel. The search algorithm may also be able to determine if a high side or a low side injection provides better receive performance, thereby allowing for a signal quality metric to be developed for this purpose. One possibility to be investigated is monitoring the high frequency RSSI relative to the total RSSI. The IF may be chosen so that with the timing accuracy that a receiver may be enabled to provide, the image channels may comprise a frequency error that is sufficiently large to differentiate the image channels from the on channel.

The CPU 210 may enable a host controller interface (HCI) in Bluetooth. In this regard, the HCI provides a command interface to the baseband controller and link manager, and access to hardware status and control registers. The HCI may provide a method of accessing the Bluetooth baseband capabilities that may be supported by the CPU 210.

The memory 212 may comprise suitable logic, circuitry, and/or code that may enable data storage. In this regard, the memory 212 may be utilized to store data that may be utilized by the processor system 202 to control and/or manage the operations of the single chip 200. The memory 212 may also be utilized to store data received by the single chip 200 via the PTU 204 and/or via the FM core 208. Similarly, the memory 212 may be utilized to store data to be transmitted by the single chip 200 via the PTU 204 and/or via the FM core 208. The DMA controller 214 may comprise suitable logic, circuitry, and/or code that may enable transfer of data directly to and from the memory 212 via the common bus 201 without involving the operations of the CPU 210.

The PTU 204 may comprise suitable logic, circuitry, and/or code that may enable communication to and from the single chip 200 via a plurality of communication interfaces. In some instances, the PTU 204 may be implemented outside the single chip 200, for example. The PTU 204 may support analog and/or digital communication with at least one port. For example, the PTU 204 may support at least one universal series bus (USB) interface that may be utilized for Bluetooth data communication, at least one secure digital input/output (SDIO) interface that may also be utilized for Bluetooth data communication, at least one universal asynchronous receiver transmitter (UART) interface that may also be utilized for Bluetooth data communication, and at least one I²C bus interface that may be utilized for FM control and/or FM and RDS/RBDS data communication. The PTU 204 may also support at least one PCM interface that may be utilized for Bluetooth data communication and/or FM data communication, for example.

The PTU 204 may also support at least one inter-IC sound (I²S) interface, for example. The I²S interface may be utilized to send high fidelity FM digital signals to the CPU 210 for processing, for example. In this regard, the I²S interface in the PTU 204 may receive data from the FM core 208 via a bus 203, for example. Moreover, the I²S interface may be utilized to transfer high fidelity audio in Bluetooth. For example, in the A2DP specification there is support for wideband speech that utilizes 16 kHz of audio. In this regard, the I²S interface may be utilized for Bluetooth high fidelity data communication and/or FM high fidelity data communication. The I²S interface may be a bidirectional interface and may be utilized to support bidirectional communication between the PTU 204 and the FM core 208 via the bus 203. The I²S interface may be utilized to send and receive FM data from external devices such as coder/decoders (CODECs) and/or other devices that may further process the I²S data for transmission, such as local transmission to speakers and/or headsets and/or remote transmission over a cellular network, for example. In some instances, the I²S interface may operate based on a clock that may have a similar rate but be different from a clock utilized by the processor system 202, for example. The single chip 200 may comprise circuitry that may be utilized to account for any jitter that may arise from the use of separate clocks, for example.

The Bluetooth core 206 may comprise suitable logic, circuitry, and/or code that may enable reception and/or transmission of Bluetooth data. The Bluetooth core 206 may comprise a Bluetooth transceiver 229 that may perform reception and/or transmission of Bluetooth data. In this regard, the Bluetooth core 206 may support amplification, filtering, modulation, and/or demodulation operations, for example. The Bluetooth core 206 may enable data to be transferred from and/or to the processor system 202, the PTU 204, and/or the FM core 208 via the common bus 201, for example.

The FM core 208 may comprise suitable logic, circuitry, and/or code that may enable reception and/or transmission of FM data. The FM core 208 may comprise an FM transceiver 222 and a local oscillator (LO) 227. The FM transceiver 222 may comprise suitable logic, circuitry, and/or code that may enable amplification, filtering, modulation, and/or demodulation operations of analog FM radio signals and/or digital processing of digital FM radio signals. In this regard, the FM transceiver 222 may comprise an analog-to-digital (A/D) converter 224 and a digital-to-analog (D/A) converter 228. The LO 227 may be utilized to generate at least one reference signal that may be utilized by the FM core 208 for performing analog and/or digital operations. The FM core 208 may enable transfer of data from and/or to the processor system 202, the PTU 204, and/or the Bluetooth core 206 via the common bus 201, for example.

The FM core 208 may receive analog FM data via the FM transceiver 222. The A/D converter 224 in the FM transceiver 222 may be utilized to convert the analog FM data to digital FM data to enable processing by the FM core 208. The FM core 208 may also enable the transmission of analog FM data. The FM transceiver 222 may utilize the D/A converter 228 to convert digital FM data to analog FM data to enable transmission or broadcasting. Data received by the FM core 208 may be routed out of the FM core 208 in digital format via the common bus 201 and/or in analog format via the bus 203 to the I²S interface in the PTU 204, for example.

The FM core 208 may enable radio transmission and/or reception at various frequencies, such as, 400 MHz, 900 MHz, 2.4 GHz and/or 5.8 GHz, for example. The FM core 208 may also support operations at the standard FM band comprising a range of about 76 MHz to 108 MHz, for example.

The FM core 208 may also enable communication of RDS data and/or RBDS data, such as for in-vehicle radio receivers, for example. In this regard, the FM core 208 may enable filtering, amplification, modulation, and/or demodulation of RDS/RBDS data. The RDS/RBDS data may comprise, for example, a traffic message channel (TMC) that provides traffic information that may be communicated and/or displayed to an in-vehicle user.

Digital circuitry within the FM core 208 may be operated based on a clock signal generated by dividing down a signal generated by the LO 227. The LO 227 may be programmable in accordance with the various channels that may be utilized by the FM core 208 and the divide ratio may be varied in order to maintain the digital clock signal close to a nominal value.

The RDS/RBDS data may be buffered in the memory 212 in the processor system 202. The RDS/RBDS data may be transferred from the memory 212 via the I²C interface when the CPU 210 is in a sleep or stand-by mode. For example, the FM core 208 may post RDS data into a buffer in the memory 212 until a certain level is reached and an interrupt is generated to wake up the CPU 210 to process the RDS/RBDS data. When the CPU 210 is not in a sleep mode, the RDS data may be transferred to the memory 212 via the common bus 201, for example. Moreover, the RDS/RBDS data received via the FM core 208 may be transferred to any of the ports communicatively coupled to the PTU 204 via the HCI scheme supported by the single chip 200, for example. The RDS/RBDS data may also be transferred to the Bluetooth core 206 for communication to Bluetooth-enabled devices.

The single chip 200 may operate in a plurality of modes. The U.S. application Ser. No. 11/286,55, filed on Nov. 22, 2005, discloses a method and system for a single chip integrated Bluetooth and FM radio transceiver and baseband processor, and is hereby incorporated herein by reference in its entirety.

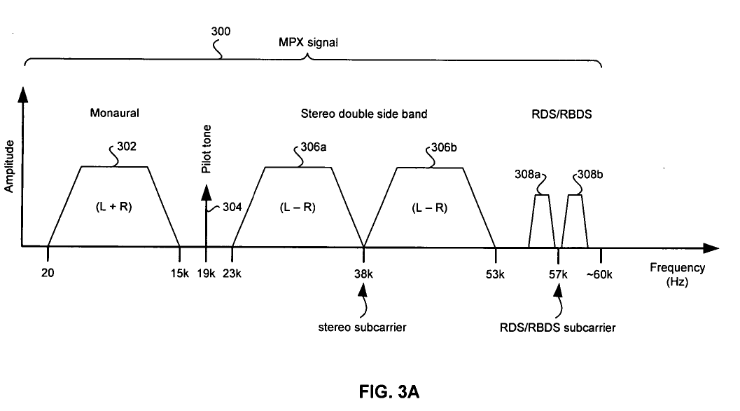

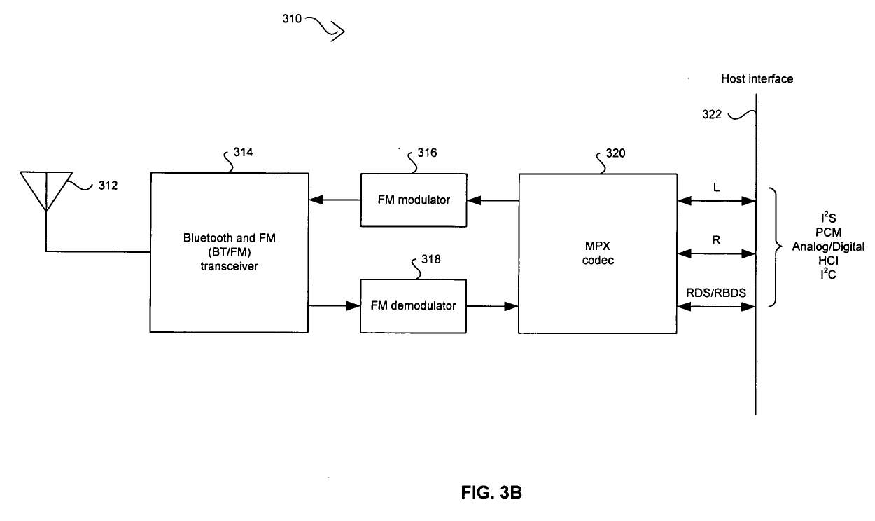

FIG. 3A is a diagram illustrating an exemplary multiplexed audio signal, in accordance with an embodiment of the invention. Referring to FIG. 3A, there is shown a multiplexed (MPX) audio signal 300 that may comprise a monaural audio signal 302, a pilot tone 304, a stereo audio signal comprising a lower sideband 306a, and an upper sideband 306b, and an RDS and/or RBDS (RBS/RBDS) signal comprising a lower sideband 308a, and an upper sideband 308b.

The monaural audio signal 302 may comprise a sum (L+R) of amplitudes of signals from a left (L) stereo channel and a right (R) stereo channel. The monaural signal 302 may enable non-stereo FM receivers to receive audio information from an FM signal. The monaural audio signal 302 may comprise a baseband signal. The frequency range of the baseband signal may comprise approximately 20 Hz to about 15 kHz. The baseband signal may comprise a frequency range, which is audible to a human of average hearing ability. The pilot tone 304 may indicate that the demodulated FM signal comprises stereo audio information. The pilot tone 304 may be located at a frequency of approximately 19 kHz.

The stereo audio signal may comprise a difference (L−R) of amplitudes between signals from the L stereo channel and the R stereo channel. The stereo audio signal may be amplitude modulated by a stereo subcarrier signal. The frequency of the stereo subcarrier signal may be equal to about 38 kHz, or that of a second harmonic of the frequency of the pilot signal 304. The result may be a double sideband signal comprising a lower sideband 306a, and an upper sideband 306b. The lower sideband 306a may comprise a range of frequencies, from about 23 kHz to about 38 kHz, that are not greater than the frequency of the stereo subcarrier signal. The upper sideband 306b may comprise a range of frequencies, from about 38 kHz to about 53 kHz, that are not less than the frequency of the stereo subcarrier signal.

The RDS/RBDS signal may comprise data. The RDS/RBDS signal may be modulated by an RDS/RBDS subcarrier signal with a frequency of about 57 kHz, or that of a third harmonic of the frequency of the pilot signal 304. The result may be a double sideband signal comprising a lower sideband 308a, and an upper sideband 308b. The lower sideband 308a may comprise a range of frequencies, from about 55.6 kHz to about 56.8 kHz, that are not greater than the frequency of the RDS/RBDS subcarrier signal. The upper sideband 308b may comprise a range of frequencies, from about 57.2 kHz to about 58.4 kHz, that are not less than the frequency of the RDS/RBDS subcarrier signal.

In operation, the monaural signal 302, stereo lower sideband signal 306a, and stereo upper sideband signal 306b may comprise a substantial portion of the total radiated energy in an FM signal. Consequently, the amplitudes of the monaural signal 302, the stereo lower sideband signal 306a, and/or the stereo upper sideband signal 306b may be greater than the corresponding amplitudes of the pilot tone 304, the RDS/RBDS lower sideband signal 308a, and/or the RDS/RBDS upper sideband signal 308b.

FIG. 3B is a block diagram illustrating an exemplary integrated Bluetooth and FM transceiver and an MPX CODEC, in accordance with an embodiment of the invention. Referring to FIG. 3B, there is shown a system 310 that may comprise an antenna 312, a Bluetooth and FM (BT/FM) transceiver 314, an FM modulator 316, an FM demodulator 318, an MPX CODEC 320, and a host interface 322. The Bluetooth and FM (BT/FM) transceiver 314, the FM modulator 316, the FM demodulator 318, and the MPX CODEC 320 may be integrated as part of a single BT/FM chip or integrated circuit as illustrated in FIG. 2.

The antenna 312 may comprise suitable logic and/or circuitry that may enable reception and/or transmission of BT and/or FM signals. In an embodiment of the invention, the antenna 312 may comprise at least one antenna for reception and/or transmission of BT and/or FM signals. The BT/FM transceiver 314 may comprise suitable logic, circuitry, and/or code that may enable processing signals received via the antenna 312 and/or signals to be transmitted via the antenna 312. In this regard, the BT/FM transceiver 314 may enable processing of Bluetooth and/or FM signals as illustrated via FIG. 2.

The BT/FM transceiver 314 may be communicatively coupled to the FM modulator 316. The FM modulator 316 may communicate FM modulated signals to the BT/FM transceiver 314 for processing prior to transmission via the antenna 312. The FM modulated signals communicated by the FM modulator 316 may comprise multiplexed audio content as described by the MPX audio signal 300 in FIG. 3A. Moreover, the BT/FM transceiver 314 may be communicatively coupled to the FM demodulator 318. The BT/FM transceiver 314 may process FM modulated signals received via the antenna 312 and may communicate the processed FM modulated signals to the FM demodulator 318. The FM modulated signals received by the FM demodulator 318 may comprise multiplexed audio content as described by the MPX audio signal 300.

The operations supported by the BT/FM transceiver 314, the FM modulator 316, and the FM demodulator 318 may correspond to the operations provided by the Bluetooth transceiver 229 and/or the FM transceiver 222 as described in FIG. 2.

The MPX CODEC 320 may comprise suitable logic, circuitry, and/or code that may enable encoding audio content, such as L channel content, R channel content, RDS/RBDS content, and/or pilot tone information, to generate a multiplexed audio signal such as the MPX audio signal 300. The MPX CODEC 320 may also enable decoding multiplexed audio signals into its L channel content, R channel content, and/or RDS/RBDS content. The U.S. application Ser. No. 11/287,075, filed on Nov. 22, 2005, discloses a method and system for a RDS demodulator for a single chip integrated Bluetooth and FM transceiver and baseband processor, and is hereby incorporated herein by reference in its entirety.

The MPX CODEC 320 may communicate audio signal content with a host interface 322. The host interface 322 may correspond to the PTU 204 in FIG. 2, for example. In this regard, the MPX CODEC 320 may receive L channel content, R channel content, and/or RDS/RBDS content from the host interface 322. Moreover, the MPX CODEC 320 may transfer L channel content, R channel content, and/or RDS/RBDS content to the host interface 322. The host interface 322 may support a plurality of interfaces. For example, the host interface 322 may support a pulse-code modulation (PCM) interface, an inter-IC sound (I²S) interface, an inter-integrated circuit (I²C) bus interface, an analog and/or digital interface, and/or a host controller interface (HCI).

In operation, audio content may be received by the MPX CODEC 320 from at least one of the interfaces supported by the host interface 322. The MPX CODEC 320 may generate a multiplexed audio signal, such as the MPX audio signal 300, from the audio content received. The MPX CODEC 320 may transfer the multiplexed audio signal to the FM modulator 316 where the multiplexed audio signal may be frequency modulated for transmission. The modulated multiplexed audio signal may be transferred to the BT/FM transceiver 314 where it may be processed for transmission via the antenna 312.

An FM signal comprising multiplexed audio content may be received by the BT/FM transceiver 314 via the antenna 312. The BT/FM transceiver 314 may process the received signal and may transfer the processed received signal to the FM demodulator 318 for demodulation. The demodulated multiplexed audio signal generated by the FM demodulator 318 may be transferred to the MPX CODEC 320 where it may be separated into L channel content, R channel content, and/or RDS/RBDS content. The MPX CODEC 320 may transfer the audio content to another device via at least one of the interfaces supported by the host interface 322.

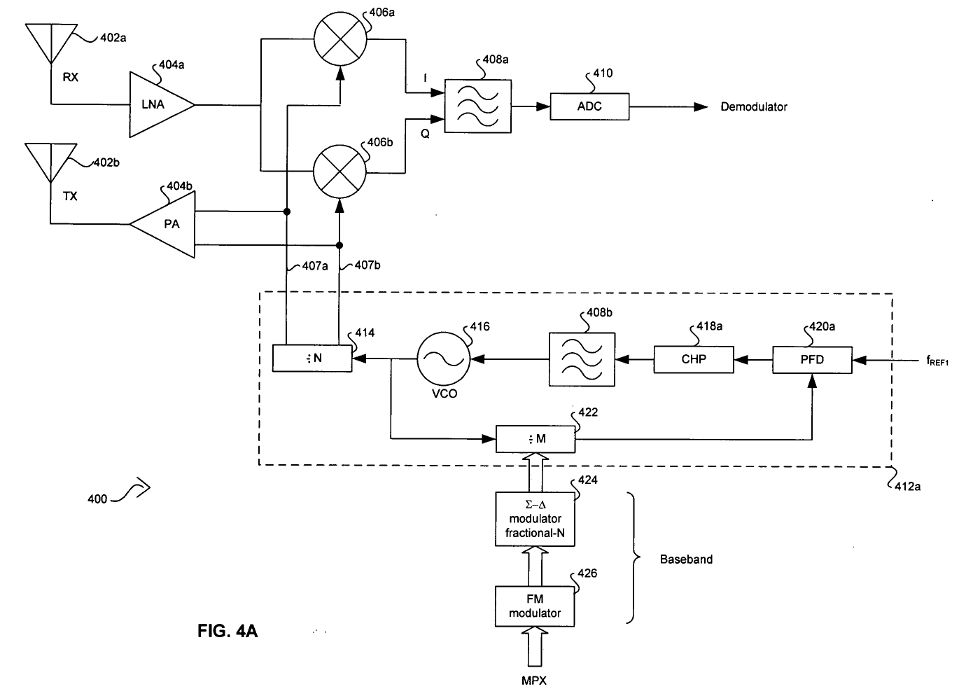

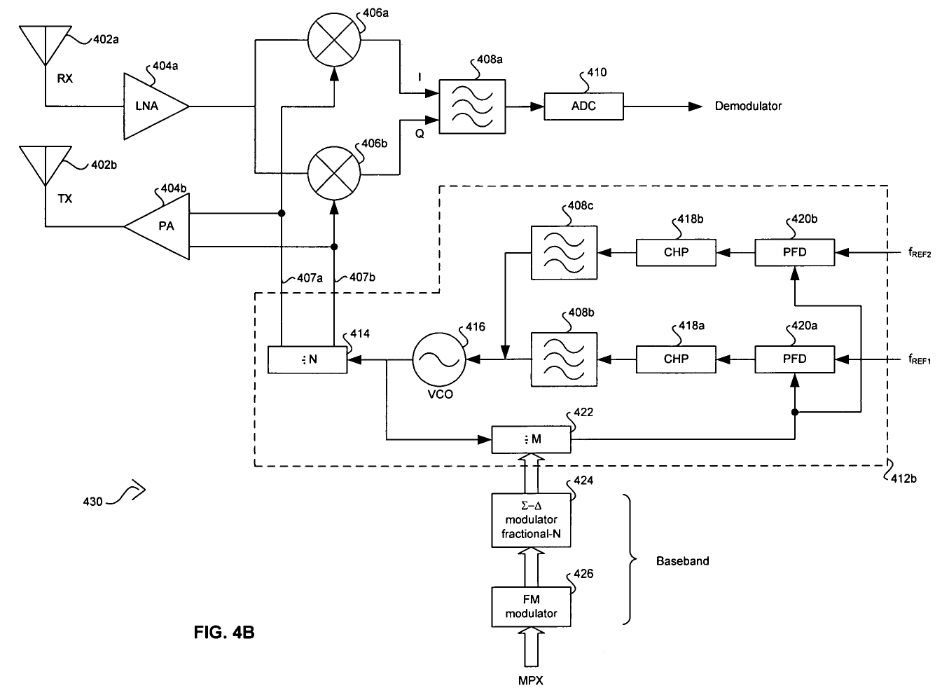

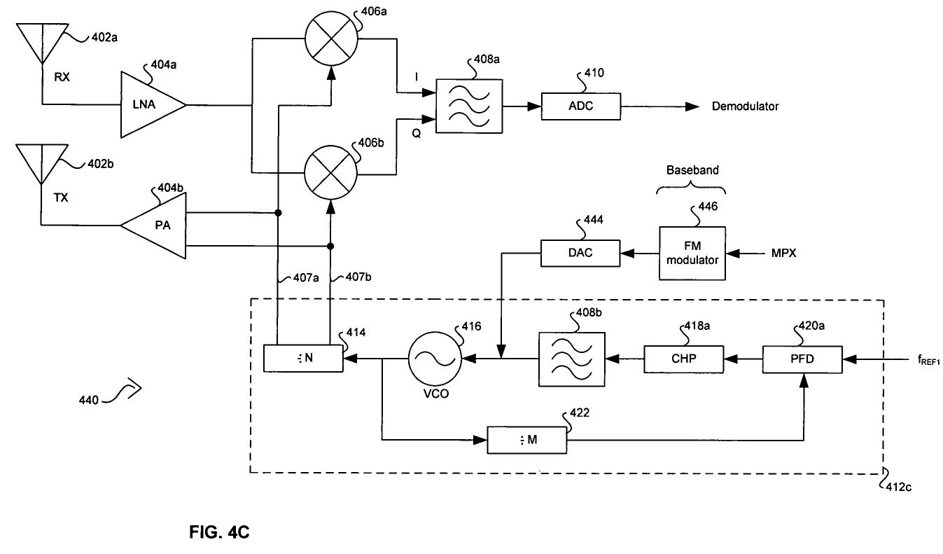

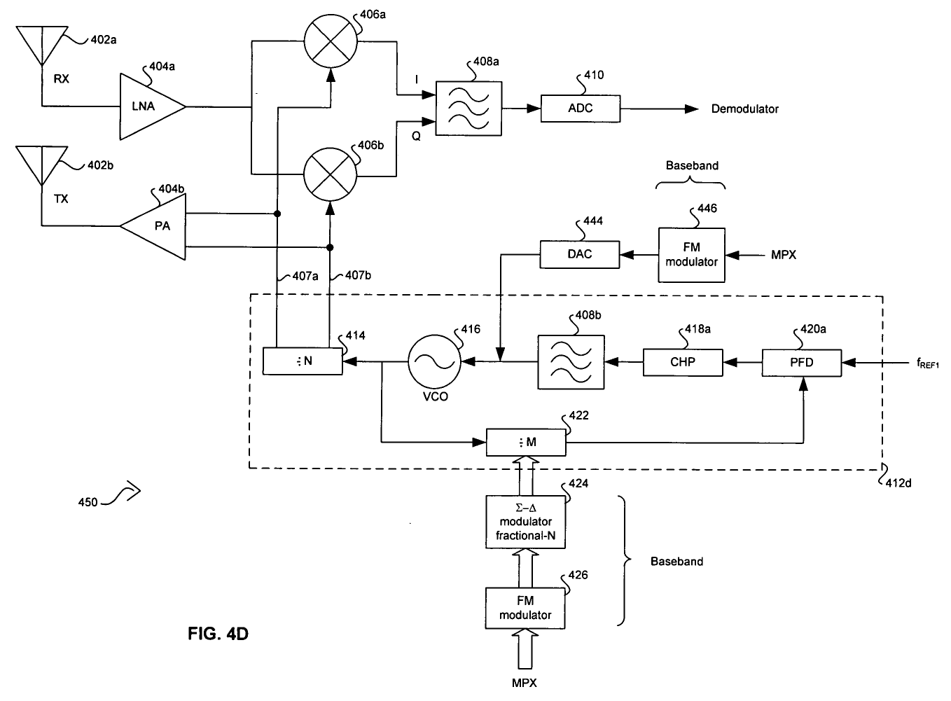

FIG. 4A is a block diagram of an exemplary single modulation point FM transceiver with modulated PLL feedback divider, in accordance with an embodiment of the invention. Referring to FIG. 4, there is shown a single modulation point FM transceiver 400 that may comprise a receive antenna 402a, a transmit antenna 402b, low noise amplifier (LNA) 404a, a power amplifier (PA) 404b, mixers 406a and 406b, filter 408a, an analog-to-digital converter (ADC) 410, and a PLL 412a. The PLL 412a may comprise a divide-by-N block 414, a voltage-controlled oscillator (VCO) 416, a filter 408b, a charge pump (CHP) 418a, a phase-frequency detector (PFD) 420a, and a divide-by-M block 422. Also shown in FIG. 4 is an FM modulator 426 and a Σ-Δ fractional-N modulator 424. The FM modulator 426 and the Σ-Δ fractional-N modulator 424 may perform baseband operations and may be implemented separately from the FM transceiver 400.

The antennas 402a and 402b may comprise suitable logic and/or circuitry that may enable reception and transmission of FM radio signals respectively. The LNA 404a and the PA 404b may comprise suitable logic, circuitry, and/or code that may enable amplifying FM radio signals. The PA 404b may enable generating large signals for transmission operations. For example, the LNA 404a may amplify FM radio signals received via the antenna 402a while the PA 404b may amplify FM radio signals to be transmitted via the antenna 402b. The mixers 406a and 406b may comprise suitable logic, circuitry, and/or code that may enable generation of in-phase (I) and quadrature (Q) baseband frequency signals from the received FM radio signals. The filter 408a may comprise suitable logic, circuitry, and/or code that may enable low pass filtering the signals generated via the mixers 406a and 406b. The filter 408a may be a polyphase filter, for example. The ADC 410 may comprise suitable logic, circuitry, and/or code that may enable digitizing the output of the filter 408a. The digitized signals produced by the ADC 410 may be communicated as an output of the ADC 410 for demodulation.

The divide-by-N block 414 may comprise suitable logic, circuitry, and/or code that may enable dividing the output of the VCO 416 by a factor N. The divide-by-N block 414 may generate two signals, signals 407a and 407b, that may be communicated to the mixers 406a and 406b respectively for down conversion of the FM signals received and to the PA 404b for generating an FM radio signal for transmission. The VCO 416 may comprise suitable logic, circuitry, and/or code that may enable generating a signal frequency, f_{VCO}, corresponding to a voltage input. In this regard, the frequency of the VCO 416 may be based on the value M in the divide-by-M block 422 in the feedback loop and on the reference frequency, f_{REF1}, and may be given by the expression f_{VCO}=M·f_{REF1}.

The filter 408b may comprise suitable logic, circuitry, and/or code that may enable low pass filtering operations in the PLL. The CHP 418a may comprise suitable logic, circuitry, and/or code that may enable conversion of DC voltages produced by the PFD 420a to other DC voltages. The CHP 418a may enable averaging the output of the PFD 420a during a plurality of phase/frequency comparisons. The PFD 420a may comprise suitable logic, circuitry, and/or code that may enable comparing phase and/or frequency values. In this regard, the PFD 420a may compare the frequency of the reference frequency, f_{REF1}, with the frequency of the signal generated by the divide-by-M block 422. The divide-by-M block 422 may comprise suitable logic, circuitry, and/or code that may enable dividing the output of the VCO by M to generate a feedback signal that may be fed back to the PFD 420a for comparison. The path comprising the PFD 420a, the CHP 418a, and the filter 408b in the PLL 412a may be referred to as a frequency path corresponding to the reference frequency f_{REF1}. The frequency path may have a corresponding loop bandwidth associated with it, where the loop bandwidth may generally be larger than the bandwidth of the baseband signal.

The FM modulator 426 may comprise suitable logic, circuitry, and/or code that may enable frequency modulating a multiplexed audio signal such as the MPX audio signal 300 in FIG. 3A. The output of the FM modulator 426 may be communicated to the Σ-Δ fractional-N modulator 424. The Σ-Δ fractional-N modulator 424 may comprise suitable logic, circuitry, and/or code that may enable generating a digital signal that corresponds to the modulated multiplexed audio signal provided by the FM modulator 426. The Σ-Δ fractional-N modulator 424 may be utilized to modulate the value of M in the divide-by-M block 422 to modulate the feedback being provided to the PFD 420a in the PLL 412a. Modulating the value M may result in modulating the output of the VCO 416 based on the expression f_{VCO}=M·f_{REF1}.

During a receive mode of operation, the single modulation point FM transceiver 400 may receive FM radio signals via the antenna 402a. The received FM radio signals may be amplified by the LNA 404a. The amplified FM radio signals may be mixed with the signals 407a and 407b in the mixers 406a and 406b to generate the received radio signals I and Q components by downconversion. The output of the mixers 406a and 406b may be filtered by the filter 408a and may then be digitized by the ADC 410 before demodulation.

During a transmit mode of operation, the FM modulator 426 may modulate a multiplexed audio signal, such as the MPX audio signal 300 in FIG. 3A. The Σ-Δ fractional-N modulator 424 may generate a signal to modulate the divide-by-M block 422 based on the modulated multiplexed audio signal provided by the FM modulator 426. The modulated feedback value provided by the divide-by-M block 422 to the PFD 420a may result in a modulated signal generated by VCO 416. The modulated output of the VCO 416 may be divided by 2 by the divide-by-two block 414 to generate signals 407a and 407b. The PA 404b may combine the signals 407a and 407b to produce FM radio signals for transmission via the antenna 402.

FIG. 4B is a block diagram of an exemplary single modulation point FM transceiver with additional reference frequency path in PLL for transmission operations, in accordance with an embodiment of the invention. Referring to FIG. 4B, there is shown a single modulation point FM transceiver 430 that may differ from the single modulation point FM transceiver 400 in FIG. 4A in that a PLL 412b is being utilized in the single modulation point FM transceiver 430. The PLL 412b may comprise the divide-by-N block 414, the VCO 416, the filter 408b, the CHP 418a, the PFD 420a, and the divide-by-M block 422. The path comprising the PFD 420b, the CHP 418a, and the filter 408b in the PLL 412a may be referred to as a first frequency path corresponding to the reference frequency f_{REF1}. The frequency path may have a corresponding loop bandwidth associated with it, where the loop bandwidth may generally be larger than the bandwidth of the baseband signal.

In some instances, the loop bandwidth provided by the first frequency path may not be sufficient for a transmit mode of operation. In this regard, the PLL 412b may comprise at least a second frequency path corresponding to the reference frequency f_{REF2} that comprises a filter 408c, a CHP 418b, and a PFD 420b. The filter 408c, the CHP 418b, and the PFD 420b may perform substantially the same operations as the filter 408b, the CHP 418a, and the PFD 420a. The second frequency path may have a corresponding loop bandwidth associated with it, where the loop bandwidth may be sufficiently large for transmission operations.

In operation, the single modulation point FM transceiver 430 may utilize, during a receive mode of operation, the first frequency path in the PLL 412b associated with the reference frequency f_{REF1}, that is, the path comprising the filter 408b, the CHP 418a, and the PFD 420a, for generating the signals 407a and 407b to be utilized by the mixers 406a and 406b for downconverting received FM radio signals. The single modulation point FM transceiver 430 may utilize, during a transmit mode of operation, the second frequency path in the PLL 412b associated with the reference frequency f_{REF2}, that is, the path comprising the filter 408c, the CHP 418b, and the PFD 420b, for generating the signals 407a and 407b to be utilized by the PA 404b to generate the FM radio signals to be transmitted via the antenna 402b. During the transmit mode of operation, the output of the VCO 416 may be modulated based on the multiplexed audio signal via the FM modulator 426 and the Σ-Δ fractional-N modulator 424.

FIG. 4C is a block diagram of an exemplary single modulation point FM transceiver with added modulated transmit signal to VCO, in accordance with an embodiment of the invention. Referring to FIG. 4C, there is shown a single modulation point FM transceiver 440 that may differ from the single modulation point FM transceiver 400 in FIG. 4A in that a PLL 412c is being utilized in the single modulation point FM transceiver 440. There is also shown in FIG. 4C a digital-to-analog converter (DAC) 444 and an FM modulator 446. The FM modulator 446 may be the same or substantially similar to the FM modulator 426 in FIGS. 4A and 4B. In this regard, the FM modulator 446 may perform baseband operations and may be implemented separately from the FM transceiver 440. The DAC 444 may comprise suitable logic, circuitry, and/or code that may be utilized to digitize modulated multiplexed audio signals from the FM modulator 446.

The PLL 412c may differ from the PLL 412a in FIG. 4A in that the modulated multiplexed audio signal from the DAC 444 may be introduced to the VCO 416 by a second varactor modulation point or by analog addition of the control voltage from the loop filter 408b and the output of the DAC 444, for example. Moreover, the divide-by-M block 422 in the PLL 412c need not be enabled for external modulation. This approach may enable single point modulation of the VCO 416 output with the modulated multiplexed audio signal without performing the modulation in the feedback loop. Moreover, this approach may enable single point modulation that utilizes a PLL design with a single frequency path.

In operation, during a transmit mode of operation, the FM modulator 446 may modulate the multiplexed audio signal and may transfer the modulated multiplexed audio signal to the DAC 444. The modulated multiplexed audio signal may be added to the output of the filter 408b in the PLL 412c to modulate the VCO 416. The modulated output of the VCO 416 may be utilized to generate signals 407a and 407b. The PA 404b may combine signals 407a and 407b to generate FM radio signals that may be transmitted via the antenna 402b.

FIG. 4D is a block diagram of an exemplary double modulation point FM transceiver, in accordance with an embodiment of the invention. Referring to FIG. 4D, there is shown a double modulation point FM transceiver 450 that may differ from the single modulation point FM transceiver 400 in FIG. 4A in that a PLL 412d is being utilized in the double modulation point FM transceiver 450. There is also shown in FIG. 4D the FM modulator 426 and the Σ-Δ fractional-N modulator 424 as described in FIGS. 4A and 4B and the DAC 444 and the FM modulator 446 as described in FIG. 4C. The FM modulator 426, the Σ-Δ fractional-N modulator 424, and the FM modulator 446 may perform baseband operations and may be implemented separately from the FM transceiver 450.

The PLL 412d may differ from the PLL 412a in FIG. 4A in that the modulated multiplexed audio signal from the DAC 444 may be introduced to the VCO 416 by a second varactor modulation point or by analog addition of the control voltage from the loop filter 408b and the output of the DAC 444, for example. This configuration enables a first modulation point for the double modulation point FM transceiver 450. Moreover, the divide-by-M block 422 in the PLL 412d provides for external modulation by the Σ-Δ fractional-N modulator 424, thus enabling a second modulation point for the double modulation point FM transceiver 450.

In operation, during a transmit mode of operation, the FM modulator 446 may modulate the multiplexed audio signal and may transfer the modulated multiplexed audio signal to the DAC 444. The modulated multiplexed audio signal may be added to the output of the filter 408b in the PLL 412c to provide a first modulation point of the VCO 416. Moreover, the FM modulator 426 may also modulate the multiplexed audio signal. The Σ-Δ fractional-N modulator 424 may then generate a signal to modulate value of M in the divide-by-M block 422 based on the modulated multiplexed audio signal provided by the FM modulator 426. The modulated feedback value provided by the divide-by-M block 422 to the PFD 420a may provide a second modulation point of the VCO 416. The modulated output of the VCO 416 may be divided by 2 by the divide-by-two block 414 to generate signals 407a and 407b. The PA 404b may combine the signals 407a and 407b to produce FM radio signals for transmission via the antenna 402.

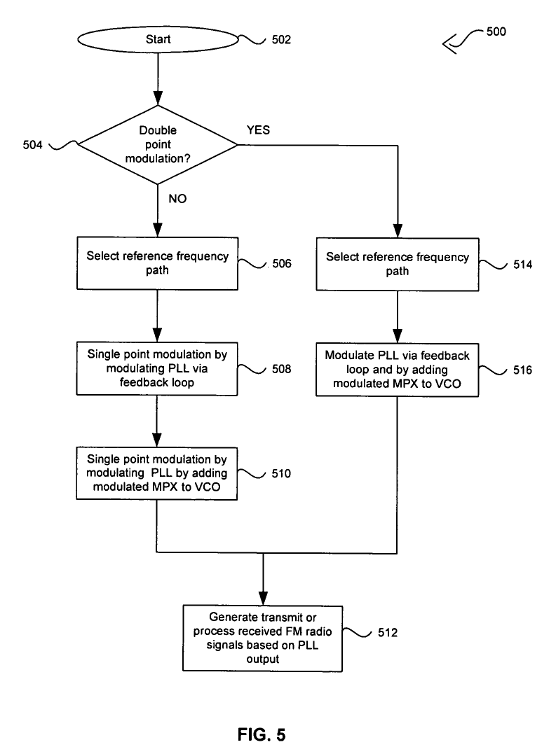

FIG. 5 is a flow diagram of the operation of an FM transceiver with at least one modulation point, in accordance with an embodiment of the invention. Referring to FIG. 5, there is shown a flow diagram 500. In step 504, after start step 502, when the FM transceiver is to provide single point modulation the process may proceed to step 506. In step 506, the appropriate reference frequency path may be selected when more than one reference frequency paths are available in the single PLL, as shown in FIG. 4B, for example. In step 508, single point modulation may be provided via the PLL's feedback loop as shown in FIGS. 4A and 4B, for example. In step 510, single point modulation may also be provided by adding the frequency modulated multiplexed audio signal to the input of the VCO 416 in the PLL, as shown in FIG. 4C. In step 512, the FM transceiver may be enabled to generate transmit FM radio signals or to process received FM radio signals based on the single point modulation of the PLL.

Returning to step 504, when the FM transceiver is to provide double point modulation the process may proceed to step 514. In step 514, the appropriate reference frequency path may be selected when more than one reference frequency paths are available in the single PLL. In step 516, double point modulation may be provided via the PLL's feedback loop and by adding the frequency modulated multiplexed audio signal to the input of the VCO 416 in the PLL. In step 512, the FM transceiver may be enabled to generate transmit FM radio signals or to process received FM radio signals based on the double point modulation of the PLL.

In an embodiment of the invention, an FM transceiver, such as the FM transceiver 450 described in FIG. 4A, for example, may comprise a single PLL 412d, that may enable generating an FM radio signal for transmission from the FM transceiver by modulating the single PLL 412d via at least one modulation point with a frequency modulated multiplexed audio signal. The single PLL 412d also generates signals for downconversion of FM radio signals received by the FM transceiver. Circuitry within the FM transceiver 450 may enable modulating the single PLL 412d via a first of the at least one modulation point in a feedback loop. The single PLL 412d may comprise a signal divider, such as the divide-by-M block 422, in the feedback loop, that enables modulating the single PLL 412d.

The FM transceiver 450 may comprise circuitry that enables modulating the single PLL 412d via a second of the at least one modulation point by adding the modulated multiplexed audio signal to an input of the VCO 416 within the single PLL 412d. The FM transceiver 450 may also enable modulating the single PLL 412d via a first of the at least one modulation point in a feedback loop in the single PLL 412d and via a second of the at least one modulation point by adding the modulated multiplexed audio signal to an input of the VCO 416.

In another embodiment of the invention, an FM transceiver, such as the FM transceiver 430 described in FIG. 4B, may enable selecting one of a plurality of reference frequency paths within the single PLL 412b for generating an FM radio signal for transmission.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing radio frequency signals, the method comprising:
generating an FM radio signal for transmission from an FM transceiver by modulating a single PLL within said FM transceiver via at least one modulation point with a frequency modulated multiplexed audio signal, wherein said single PLL generates signals for downconversion of FM radio signals received by said FM transceiver.

2. The method according to claim 1, further comprising modulating said single PLL via a first of said at least one modulation point in a feedback loop.

3. The method according to claim 2, further comprising modulating a signal divider in said feedback loop in said single PLL.

4. The method according to claim 1, further comprising selecting one of a plurality of reference frequency paths within said single PLL for generating said FM radio signal for transmission.

5. The method according to claim 1, further comprising modulating said single PLL via a second of said at least one modulation point by adding said modulated multiplexed audio signal to an input of a VCO within said single PLL.

6. The method according to claim 1, further comprising modulating said single PLL via a first of said at least one modulation point in a feedback loop in said single PLL and via a second of said at least one modulation point by adding said modulated multiplexed audio signal to an input of a VCO within said single PLL.

7. The method according to claim 6, further comprising modulating a signal divider in said feedback loop.

8. A system for processing radio frequency signals, the system comprising:
circuitry within a single chip that generates an FM radio signal for transmission from an FM transceiver by modulating a single PLL within said FM transceiver via at least one modulation point with a frequency modulated multiplexed audio signal, wherein said single PLL generates signals for downconversion of FM radio signals received by said FM transceiver.

9. The system according to claim 8, wherein said circuitry within a single chip modulates said single PLL via a first of said at least one modulation point in a feedback loop.

10. The system according to claim 9, wherein said circuitry within a single chip modulates a signal divider in said feedback loop in said single PLL.

11. The system according to claim 8, wherein said circuitry within a single chip selects one of a plurality of reference frequency paths within said single PLL for generating said FM radio signal for transmission.

12. The system according to claim 8, wherein said circuitry within a single chip modulates said single PLL via a second of said at least one modulation point by adding said modulated multiplexed audio signal to an input of a VCO within said single PLL.

13. The system according to claim 8, wherein said circuitry within a single chip modulates said single PLL via a first of said at least one modulation point in a feedback loop in said single PLL and via a second of said at least one modulation point by adding said modulated multiplexed audio signal to an input of a VCO within said single PLL.

14. The system according to claim 13, wherein said circuitry within a single chip modulates a signal divider in said feedback loop.

15. A system for processing radio signals, the system comprising:
an FM transceiver comprising a single PLL;
said single PLL enables generating an FM radio signal for transmission from said FM transceiver by modulating said single PLL via at least one modulation point with a frequency modulated multiplexed audio signal, wherein said single PLL generates signals for downconversion of FM radio signals received by said FM transceiver.

16. The system according to claim 15, wherein circuitry within said FM transceiver enables modulating said single PLL via a first of said at least one modulation point in a feedback loop.

17. The system according to claim 16, wherein said single PLL comprises a signal divider in said feedback loop that enables modulating said single PLL.

18. The system according to claim 15, wherein circuitry within said FM transceiver enables selecting one of a plurality of reference frequency paths within said single PLL for generating said FM radio signal for transmission.

19. The system according to claim 15, wherein circuitry within said FM transceiver enables modulating said single PLL via a second of said at least one modulation point by adding said modulated multiplexed audio signal to an input of a VCO within said single PLL.

20. The system according to claim 15, wherein circuitry within said FM transceiver enables modulating said single PLL via a first of said at least one modulation point in a feedback loop in said single PLL and via a second of said at least one modulation point by adding said modulated multiplexed audio signal to an input of a VCO within said single PLL.

21. The system according to claim 20, wherein said single PLL comprises a signal divider in said feedback loop that enables modulating said single PLL.
